(19) United States
(12) Patent Application Publication
(10) Pub. No.: US 2024/0268478 A1
(43) Pub. Date: Aug. 15, 2024

(54) CARTRIDGE AND AEROSOL GENERATING DEVICE INCLUDING THE SAME

(71) Applicant: KT&G CORPORATION, Daedeok-gu, Daejeon (KR)

(72) Inventors: Wonkyeong LEE, Yuseong-gu, Daejeon (KR); Paul Joon SUNWOO, Yuseong-gu, Daejeon (KR); Byungsung CHO, Yuseong-gu, Daejeon (KR)

(73) Assignee: KT&G CORPORATION, Daedeok-gu, Daejeon (KR)

(21) Appl. No.: 18/021,732

(22) PCT Filed: Nov. 3, 2022
(86) PCT No.: PCT/KR2022/017133

§ 371 Date: Feb. 16, 2023

(30) Foreign Application Priority Data
Nov. 11, 2021 (KR) 10-2021-0154507

(51) Int. Cl. A24F 40/53; A24F 40/10; A24F 40/42; A24F 40/57; G06F 21/44

(52) U.S. Cl. CPC A24F 40/53; A24F 40/10; A24F 40/42; A24F 40/57; G06F 21/44

(57) ABSTRACT

A cartridge for an aerosol generating device includes a mouthpiece through which an aerosol formed by heating an aerosol-forming substrate is discharged and an information storage element formed at an end portion of a side where the cartridge couples to a device and configured to store unique information of the cartridge. Different pieces of the unique information of the cartridge may be stored according to a physical structure of the information storage element which forms a specific pattern.

### CROSS REFERENCE TO RELATED APPLICATIONS

This application is a National Stage of International Application No. PCT/KR2022/017133 filed Nov. 3, 2022, claiming priority based on Korean Patent Application No. 10-2021-0154507 filed Nov. 11, 2021.

### TECHNICAL FIELD

The following description relates to a cartridge and the aerosol generating device including the same.

### BACKGROUND ART

In recent years, there has been increasing demand for alternative methods to overcome disadvantages of conventional cigarettes. For example, there is increasing demand for an aerosol generating device that generates an aerosol by heating an aerosol-generating material rather than by burning a cigarette. Accordingly, research into a heating-type cigarette or a heating-type aerosol generator has been actively conducted. For example, Korean Patent Publication No. 10-2013-0036585 discloses an aerosol inhalation device.

### DISCLOSURE OF THE INVENTION

### Technical Goals

An aspect according to an example embodiment may provide a cartridge for an aerosol generating device and the aerosol generating device, which may easily transmit unique information of the cartridge to a device.

An aspect according to an example embodiment may provide a cartridge for an aerosol generating device and the aerosol generating device, which may recognize a cartridge without a sensor for recognizing the cartridge in the aerosol generating device, and thus reduce the weight and production cost of the aerosol generating device and accurately obtain unique information of the cartridge.

### Technical Solutions

According to an aspect, there is provided a cartridge for an aerosol generating device, the cartridge including a mouthpiece through which an aerosol formed by heating an aerosol-forming substrate is discharged, and an information storage element formed at an end portion of a side where the cartridge couples to a device and configured to store unique information of the cartridge. Different pieces of the unique information of the cartridge may be stored according to a physical structure of the information storage element which forms a specific pattern.

The cartridge may further include a liquid storage configured to store the aerosol-forming substrate, and a heater installed inside the liquid storage and including a wick and a heating coil.

The specific pattern may be formed by one or more protrusions and one or more recesses and represents the unique information of the cartridge differently according to a number of the protrusions, a number of the recesses, positions of the protrusions, and positions of the recesses. The information storage element may include a first storage area configured to store first information of the cartridge, a second storage area configured to store second information of the cartridge, and a third storage area configured to store third information of the cartridge. The specific pattern may represent the unique information of the cartridge differently according to a combination of the protrusions and the recesses in each of the first storage area to the third storage area.

The specific pattern may be formed by two or more electrodes, and represents the unique information of the cartridge differently according to a number of the electrodes and positions of the electrodes.

The information storage element may include a first storage area configured to store first information of the cartridge, a second storage area configured to store second information of the cartridge, and a third storage area configured to store third information of the cartridge. The specific pattern may represent the unique information of the cartridge differently according to positions of the electrodes in each of the first storage area to the third storage area and a number of the electrodes in each of the first storage area to the third storage area. According to another aspect, there is provided an aerosol generating device including a cartridge and a main body. The cartridge may include a liquid storage configured to store an aerosol-forming substrate, a heater installed inside the liquid storage and including a wick and a heating coil, a mouthpiece through which an aerosol formed by heating the aerosol-forming substrate is discharged, and an information storage element formed at an end portion of a side where the cartridge couples to a main body, and configured to store unique information of the cartridge, wherein the information storage element has a physical structure having a specific pattern which represents the unique information of the cartridge. The main body may include a power supply configured to supply power for heating the heating coil of the heater of the cartridge, a housing configured to accommodate the power supply, a cartridge recognizer configured to contact the information storage element of the cartridge to recognize the unique information of the cartridge, and a controller configured to control a temperature of the heater of the cartridge, wherein the main body couples to the cartridge. The controller of the main body may control an operation of the aerosol generating device, based on the unique information of the cartridge recognized by the cartridge recognizer.

The specific pattern may be formed by one or more protrusions, and represents the unique information of the cartridge differently according to a number of the protrusions, a number of the recesses, positions of the protrusions, and positions of the protrusions. The cartridge recognizer of the main body may include physical switches provided in a number that is equal to a sum of the number of the protrusions and the number of the recesses, and recognizes the unique information of the cartridge based on at least one of the physical switches being clicked by the protrusions of the cartridge.

The specific pattern may be formed by two or more electrodes, and represents the unique information of the cartridge differently according to a number of the electrodes and positions of the electrodes. The cartridge recognizer of the main body may include recognition terminals provided in a number that is greater than or equal to the number of the electrodes, and recognizes the unique information of the cartridge based on a current which flows through at least one of the recognition terminals contacting the electrodes of the cartridge.

The electrodes of the information storage element of the cartridge may include one or more positive electrodes and one or more negative electrodes, the cartridge recognizer of the main body may include a negative electrode pad including two or more negative electrode terminals and a positive electrode pad including two or more positive electrode terminals, and each of the positive electrodes and the negative electrodes may correspond one-on-one to one of the negative electrode terminals of the negative electrode pad and the positive electrode terminals of the positive electrode pad.

The unique pattern about the information storage element of the cartridge may be pre-stored in the main body, and the controller may authenticate the cartridge based on whether the recognized unique pattern matches the pre-stored unique pattern.

The controller may generate an alarm, or block an operation of the aerosol generating device, when the authentication fails.

The controller of the main body may adjust a heating temperature of the heater of the cartridge, based on the unique information of the cartridge recognized by the cartridge recognizer.

### Effects

A cartridge for an aerosol generating device and the aerosol generating device according to an example embodiment may easily transmit unique information of the cartridge to a device.

A cartridge for an aerosol generating device and the aerosol generating device according to an example embodiment may recognize a cartridge without a sensor for recognizing the cartridge in the aerosol generating device, thus reducing the weight and production cost of the aerosol generating device and accurately obtaining unique information of the cartridge.

The effects of a cartridge for an aerosol generating device and the aerosol generating device according to one example embodiment are not limited to the effects stated above, and other unmentioned effects may be clearly understood from the following description by one of ordinary skill in the art.

### BRIEF DESCRIPTION OF DRAWINGS

FIG. 1 is a cross-sectional view of an aerosol generating device according to an example embodiment.

FIG. 2 is a cross-sectional view of a cartridge for an aerosol generating device in the aerosol generating device of FIG. 1, according to an example embodiment.

FIG. 3A is an enlarged view of a portion indicated as A in the cartridge for the aerosol generating device of FIG. 2, according to an example embodiment.

FIG. 3B is an enlarged view of an information storage element indicated as A in the cartridge for the aerosol generating device of FIG. 2, according to another example embodiment.

FIG. 4 is a cross-sectional view of the aerosol generating device of FIG. 1, according to an example embodiment.

FIG. 5 is an enlarged view of a cartridge recognizer indicated as B in a device of FIG. 4, according to an example embodiment.

FIG. 6A is a diagram illustrating a state before an information storage element of a cartridge contacts a cartridge recognizer of a device, according to an example embodiment.

FIG. 6B is a diagram illustrating a state after the information storage element contacts the cartridge recognizer of the device, according to an example embodiment.

FIG. 7A is a diagram showing a state before an information storage element of a cartridge contacts a cartridge recognizer of a device, according to another example embodiment.

FIG. 7B is a diagram illustrating a state after the information storage element of the cartridge contacts the cartridge recognizer of the device, according to another example embodiment.

### BEST MODE FOR CARRYING OUT THE INVENTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof. Unless otherwise defined, all terms including technical and scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of the embodiments, a detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The constituent element, which has the same common function as the constituent element included in any one embodiment, will be described by using the same name in other embodiments. Unless disclosed to the contrary, the configuration disclosed in any one embodiment may be applied to other embodiments, and the specific description of the repeated configuration will be omitted.

Hereinafter, example embodiments of the present disclosure are described in detail with reference to the drawings.

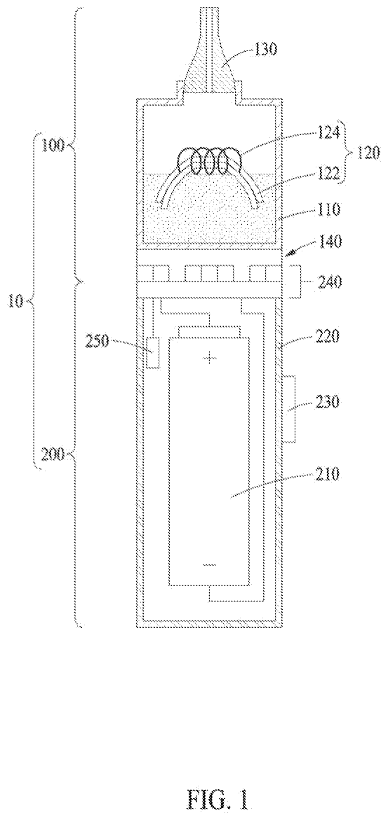

FIG. 1 is a cross-sectional view of an aerosol generating device 10 according to an example embodiment.

Referring to FIG. 1, the aerosol generating device 10 may include a cartridge 100 and a device 200 (i.e., a main body of the aerosol generating device 10). The cartridge 100 may include a liquid material for generating an aerosol is stored, and a battery storing electric power to heat the liquid material. The device 200 may be coupled to the cartridge 100. When the cartridge 100 is mounted on the device 200 of the aerosol generating device 10, the device 200 may recognize unique information of the cartridge 100 to determine whether the cartridge 100 is genuine or not and deliver power for heating to an optimal heating temperature according to the type of the mounted cartridge 100 The cartridge 100 may store different information according to a physical structure of the cartridge 100 which includes a specific pattern. The aerosol generating device 10 may recognize the unique information of the cartridge 100 and control an operation of the aerosol generating device 10 based on the recognized unique information of the cartridge 100.

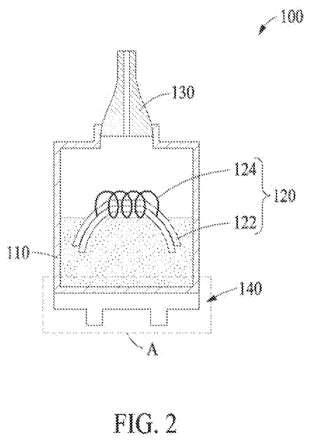

FIG. 2 is a cross-sectional view of a cartridge 100 for an aerosol generating device in the aerosol generating device of FIG. 1, according to an example embodiment.

Referring to FIG. 2, the cartridge 100 for the aerosol generating device may include a liquid storage 110, which may store an aerosol-forming substrate. The aerosol-forming substrate may refer to a material capable of forming an aerosol. The aerosol may include volatile compounds. The aerosol-forming substrate may be solid or liquid. For example, a solid aerosol-forming substrate may include a solid material based on tobacco raw materials, such as tobacco made of reconstituted tobacco leaves, cut tobacco, and reconstituted tobacco. A liquid aerosol-forming substrate may include a liquid composition material, based on nicotine, tobacco extract and/or various flavoring agents. However, the scope of the present embodiment is not limited thereto.

Continuously referring to FIG. 2, the cartridge 100 may include a heater 120 including a wick 122 and a heating coil 124. The wick 122 may include at least one of cotton fiber, ceramic fiber, glass fiber, porous ceramic, or a compound thereof, but is not limited thereto. The heating coil 124 may be wound around the wick 122 and connect to a power supply 210 of the device 200 to generate heat and heat the wick 122 so that the heated wick 122 may generate the aerosol.

Continuously referring to FIG. 2, the cartridge 100 may include a mouthpiece 130, through which the aerosol generated from the aerosol-forming substrate is discharged. The mouthpiece 130 may have a mouthpiece shape protruding from one side of the cartridge 100 as shown in FIG. 2, but is not necessarily limited thereto. For example, the mouthpiece 130 may have a shape of a bottle, a cylinder, a hole, or the like. In addition, the mouthpiece 130 may be formed of various materials, such as plastic synthetic resin, stainless steel, glass, Teflon, and rubber.

Continuously referring to FIG. 2, the cartridge 100 may include an information storage element 140 including unique information of the cartridge 100. The information storage element 140 may be at an end portion of a side where the cartridge 100 couples to the device 200. The information storage element 140 and the mouthpiece 130 may be at opposite sides of the cartridge 100. Unique information of the cartridge 100 stored in the information storage element 140 may, for example, include information about whether a cartridge 100 is genuine or not, whether a cartridge 100 is compatible with a device 200, what type of a medium is contained in the cartridge 100, what flavor the aerosol-generating substrate stored in the cartridge 100 is, and the like but may not be limited thereto. The information storage element 140 of the cartridge 100 may store the unique information of a cartridge 100 as described above according to a physical structure of the information storage element 140 which includes a specific pattern. Hereinafter, the physical structure having a specific pattern is described in more detail.

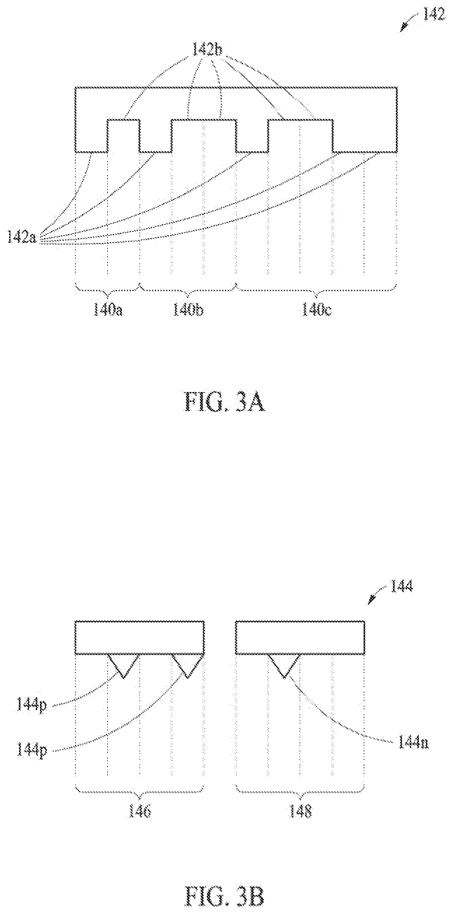

FIGS. 3A and 3B are enlarged views of a portion indicated as A in the cartridge for the aerosol generating device of FIG. 2, according to various embodiments.

FIG. 3A is the enlarged view of the portion indicated as A in the cartridge for the aerosol generating device of FIG. 2 according to an example embodiment. Information storage element 142 may store unique information of the cartridge 100 by combining a protrusion 142a physically protruding and a recess 142b physically recessed.

Referring to FIG. 3A, the information storage element 142 may include one or more protrusions 142a and one or more recesses 142b. The information storage element 142 may store different information according to the number of protrusions 142a, the number of recesses 142b, positions of the protrusions 142a, and positions of the recesses 142b. The information storage element 142 may include a plurality of blocks, and each block may include either a protrusion 142a or a recess 142b. The more the number of blocks in which the protrusions 142a and the recesses 142b are formed, the more pieces of information about the cartridge 100 the information storage element 142 may store. For example, since one of the protrusion 142a and the recess 142b may be selectively disposed in one block, the information storage element 142 having n blocks may store 2ⁿ different pieces of information about the cartridge 100. For example, as FIG. 3A illustrates a total of 10 blocks, a total of 2¹⁰ (i.e., 1024) different pieces of the unique information of the cartridge 100 may be stored.

Continuously referring to FIG. 3A, the information storage element 142 may include a plurality of partitioned areas according to the type of information to be stored about the cartridge 100. For example, referring to FIG. 3A, the information storage element 142 may include a first storage area 140a storing first information, a second storage area 140b storing second information, and a third storage area 140c storing third information. The n^{th} storage area may store unique information about the cartridge 100, such as whether a cartridge 100 is compatible with a device, what type of a medium is contained in the cartridge 100, what flavor the aerosol-generating substrate stored in the cartridge 100 is, and the like but may not be limited thereto. Each storage area may include one or more blocks in which the protrusions 142a and the recesses 142b are disposed. For example, referring to FIG. 3A, the first storage area 140a may include two blocks, the second storage area 140b may include three blocks, and the third storage area 140c may include five blocks. The more blocks the storage area has, the more pieces of information about the cartridge 100 the storage area may store. The unique information of the cartridge 100 may be stored according to the combination of the protrusions 142a and the recesses 142b in the first storage area 140a to the third storage area 140c. FIG. 3B is an enlarged view of the portion indicated as A in the cartridge for the aerosol generating device of FIG. 2, according to another example embodiment. An information storage element 144 may store unique information of the cartridge 100 according to the combination of a positive electrode 144p and a negative electrode 144n.

Referring to FIG. 3B, the information storage element 144 may include the two or more electrodes 144p and 144n, and the information storage element 144 may store different unique information of the cartridge 100 according to the combination of the numbers and positions of the electrodes 144p and 144n. The electrodes 144p and 144n may play a role of storing the information about the cartridge 100 and receiving power from a power supply 210 included in a device 200. Since positive and negative electrodes of the power supply 210 are required to connect to the negative and positive electrodes of a terminal of the cartridge 100, respectively, to receive power from the power supply 210, the electrodes of the information storage element 144 may include the positive electrode 144p and the negative electrode 144n. In this case, the electrodes 144p and 144n may include a positive electrode area 146 and a negative electrode area 148.

In addition, although not shown in FIG. 3B, the information storage element 144 may include a plurality of partitioned areas according to the type of information to be stored about the cartridge 100, similar to the information storage element 142. For example, the information storage element 144 may include a first storage area storing first information, a second storage area storing second information, and a third storage area storing third information. The n^{th} storage area may store information unique to the cartridge, such as whether a cartridge 100 is compatible with a device 200, what type of a medium is contained in the cartridge 100, what flavor the aerosol-generating substrate stored in the cartridge 100 is, and the like but may not be limited thereto. Each storage area may include the one or more electrodes 144p and 144n. The more blocks the storage area includes, the more pieces of information about the cartridge 100 the storage area can store. The unique information of the cartridge 100 may be stored according to the combination of the number of the electrodes in the first storage area 140a to the third storage area 140c and positions of the electrodes in the first storage area 140a to the third storage area 140c.

Hereinafter, a device 200 coupled to a cartridge 100 to form an aerosol generating device 10 is described in detail.

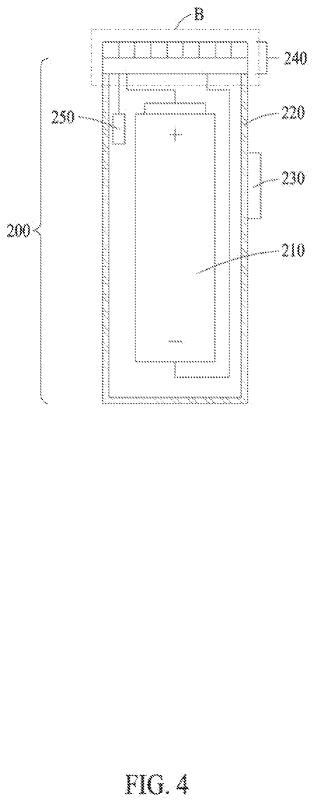

FIG. 4 is a cross-sectional view of a device 200 in the aerosol generating device 10 of FIG. 1, according to an example embodiment.

Referring to FIG. 4, the device 200 may include a power supply 210 storing power for heating a heating coil 124 in a heater 120 of a cartridge 100. In addition, the power supply 210 may supply power required for an operation of other hardware components included in the aerosol generating device 10, such as, a sensor, a user interface, a memory, a processor, and a controller. The power supply 210 may be a multi-use rechargeable battery or a disposable battery. For example, the power supply 210 may include a nickel-based battery (e.g., a nickel-metal hydride battery or a nickel-cadmium battery) or a lithium-based battery (e.g., a lithium-cobalt battery, a lithium-phosphate battery, a lithium-titanate battery, a lithium-ion battery, or a lithium-polymer battery). However, the type of the power supply 210 for the aerosol generating device 10 is not limited to those described above. The power supply 210 may include an alkaline battery or a manganese battery, as necessary.

Continuously referring to FIG. 4, the device 200 may include a housing 220 accommodating the power supply 210. The housing 220 may include other hardware components of the aerosol generating device 10 in addition to the power supply 210. In addition, the housing 220 may be manufactured in an ergonomic shape to provide a comfortable grip to a user. For example, the housing 220 may be manufactured in a cylindrical shape, a hexagonal prism shape, an octagonal prism shape, or a streamlined shape, such that the user may conveniently grip the housing 220. In addition, a switch 230 capable of controlling an operation of the aerosol generating device 10 may be on the housing 220.

Continuously referring to FIG. 4, the device 200 may include a cartridge recognizer 240, which contacts the information storage element 140 of the cartridge 100 to recognize unique information of the cartridge 100, and a controller 250 which may control a temperature of the heater 120 of the cartridge 100. The controller 250 of the device 200 may control the operation of the aerosol generating device 10 based on the unique information of the cartridge 100 recognized by the cartridge recognizer 240. Described in detail below is how the cartridge recognizer 240 contacts the information storage element 140 of the cartridge 100 to recognize the unique information of the cartridge 100 and how the controller 250 controls an operation of the aerosol generating device 10 based on the recognized unique information of the cartridge 100.

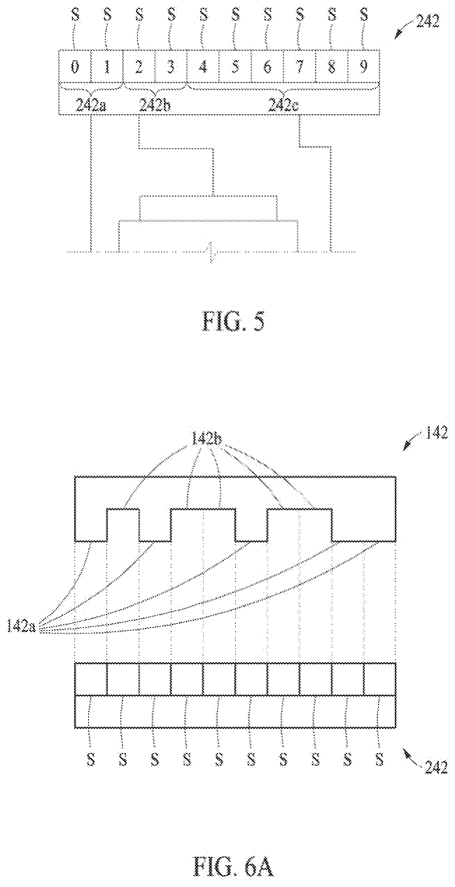

FIG. 5 is an enlarged view of a portion indicated as B of the cartridge recognizer 240 of the device 200 of FIG. 4, according to an example embodiment.

Referring to FIG. 5, the cartridge recognizer 242 may include a plurality of physical switches S. The number of physical switches S may be the same as the number of blocks, that is, a number obtained by adding the number of protrusions 142a to the number of recesses 142b in the information storage element 142. In this case, all of the physical switches S may be clicked independently. Therefore, where the cartridge 100 is mounted on the device 200 to constitute the aerosol generating device 10, the information storage element 142 of the cartridge 100 may be engaged with the cartridge recognizer 242 of the device 200. In this case, among the physical switches S of the cartridge recognizer 242 of the device 200, only physical switches in contact with the protrusions 142a of the information storage element 142 of the cartridge 100 are clicked to transmit unique information of the cartridge 100 to the device 200. When the unique information of the cartridge 100 transmitted to the device 200 is recognized by the controller 250, the controller 250 may control the overall operation of the aerosol generating device 10 according to the unique information of the cartridge 100, for example, the type of medium and the type of flavoring agent. For example, the controller 250 may transmit power to the heater 120 of the cartridge 100 to implement an optimal temperature profile according to the unique information of the cartridge 100.

Continuously referring to FIG. 5, the device 200 may pre-store an encrypted unique pattern about the information storage element 140 of the cartridge 100 to authenticate the cartridge 100. For example, the information storage element 142 of the cartridge 100 may pre-store an encrypted pattern requiring blocks corresponding to 0^{th} and 9^{th} switches of the device 200 to be formed as the protrusions 142a so that the switches S are clicked or an encrypted pattern requiring the three or more consecutive switches S to be clicked. The encrypted unique pattern for authenticating the cartridge 100 may not be limited thereto and may include various patterns. In this case, where the position and combination of the protrusions 142a and recesses 142b of the information storage element 140 of the cartridge 100 or the position and combination of the electrodes 142p and 142n do not match the encrypted pattern pre-stored in the device, the aerosol generating device 10 may generate a warning sound, transmit a warning to a display (not shown) of the device 200, or block the operation of the aerosol generating device 10.

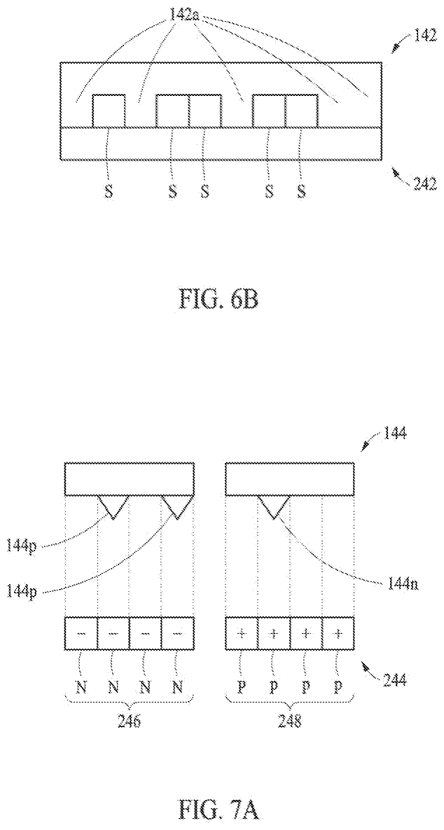

FIGS. 6A and 6B are diagrams illustrating states before and after an information storage element 142 of a cartridge 100 contacts a cartridge recognizer 242 of a device 200 according to an example embodiment, respectively.

Referring to FIGS. 6A and 6B, all of the switches S of the cartridge recognizer 242 may remain protruding, that is, in a non-click state, before the information storage element 142 of the cartridge 100 contacts the cartridge recognizer 242 of the device 200. However, only physical switches that contact the protrusions 142a of the information storage element 142 of the cartridge 100 may be clicked after the information storage element 142 of the cartridge 100 contacts the cartridge recognizer 242 of the device 200. As such, the controller 250 of the device 200 may recognize the unique information of the cartridge 100 according to the combination of the switches S clicked to control the overall operation of the aerosol generating device 10. For example, the controller 250 may adjust the heating temperature of the heater 120 of the cartridge 100, based on the unique information of the cartridge 100 recognized by the cartridge recognizer 240.

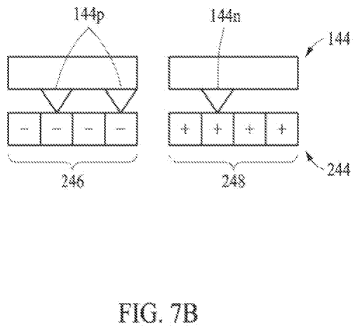

FIGS. 7A and 7B are diagrams illustrating states before and after an information storage element of a cartridge contacts a cartridge recognizer of a device, according to another embodiment.

Referring to FIGS. 7A and 7B, an information storage element 144 of a cartridge 100 may include two or more electrodes 144p and 144n and the information storage element 144 may store different unique information of the cartridge 100 according to a combination of the number of the electrodes 144p and 144n and positions of the electrodes 144p and 144n. In this case, the electrodes 144p and 144n may include one or more positive electrodes 144p and one or more negative electrodes 144n.

Continuously referring to FIGS. 7A and 7B, the cartridge recognizer 240 of the device 200 may include recognition terminals 244 in a number that is greater than or equal to the number of electrodes 144p and 144n of the information storage element 144 of the cartridge 100. The recognition terminals 244 may transmit and receive electrical signals through current delivered when in contact with the electrodes 144p and 144n of the information storage element 144 of the cartridge 100. The recognition terminals 244 in contact with the electrodes 144p and 144n may vary depending on a combination of the number of the electrodes 144p and 144n and positions of the electrodes 144p and 144n. According to the combination and the positions of the electrodes 144p and 144n, the unique information of the cartridge 100 mounted on the device 200 may be recognized differently. In this case, the recognition terminals 244 may include a negative electrode pad 246 and a positive electrode pad 248. The negative electrode pad 246 may include a plurality of negative electrode terminals N, and the positive electrode pad 248 may include a plurality of positive electrode terminals P. One positive electrode terminal P included in the positive electrode pad 248 may be in contact with one negative electrode 144n of the information storage element 144, and one negative electrode terminal N included in the negative electrode pad 246 may be in contact with one positive electrode 144p of the information storage element 144. That is, each of the positive electrode 144p and the negative electrode 144n may correspond one-on-one to one of the negative electrode terminals N of the negative electrode pad 246 and the positive electrode terminals P of the positive electrode pad 248.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

1. A cartridge for an aerosol generating device, the cartridge comprising:
a mouthpiece through which an aerosol formed by heating an aerosol-forming substrate is discharged; and
an information storage element formed at an end portion of a side where the cartridge couples to a main body of the aerosol generating device, and configured to store unique information of the cartridge,
wherein the information storage element has a physical structure including a specific pattern which represents the unique information of the cartridge.

2. The cartridge of claim 1, further comprising:
a liquid storage configured to store the aerosol-forming substrate; and
a heater installed inside the liquid storage and comprising a wick and a heating coil.

3. The cartridge of claim 1, wherein the specific pattern is formed by one or more protrusions and one or more recesses and represents the unique information of the cartridge differently according to a number of the protrusions, a number of the recesses, positions of the protrusions, and positions of the recesses.

4. The cartridge of claim 3, wherein the information storage element comprises:
a first storage area configured to store first information of the cartridge;
a second storage area configured to store second information of the cartridge; and
a third storage area configured to store third information of the cartridge,
wherein the specific pattern represents the unique information of the cartridge differently according to a combination of the protrusions and the recesses in each of the first storage area to the third storage area.

5. The cartridge of claim 1, wherein the specific pattern is formed by two or more electrodes, and represents the unique information of the cartridge differently according to a number of the electrodes and positions of the electrodes.

6. The cartridge of claim 5, wherein the information storage element comprises:
a first storage area configured to store first information of the cartridge;
a second storage area configured to store second information of the cartridge; and
a third storage area configured to store third information of the cartridge,
wherein the specific pattern represents the unique information of the cartridge differently according to positions of the electrodes in each of the first storage area to the third storage area and a number of the electrodes in each of the first storage area to the third storage area.

7. An aerosol generating device comprising:
a cartridge comprising:
a liquid storage configured to store an aerosol-forming substrate;
a heater installed inside the liquid storage and comprising a wick and a heating coil;
a mouthpiece through which an aerosol formed by heating the aerosol-forming substrate is discharged; and
an information storage element formed at an end portion of a side where the cartridge couples to a main body of the aerosol generating device, and configured to store unique information of the cartridge, wherein the information storage element has a physical structure having a specific pattern which represents the unique information of the cartridge; and
the main body comprising:
a power supply configured to supply power for heating the heating coil of the heater of the cartridge;
a housing configured to accommodate the power supply;
a cartridge recognizer configured to contact the information storage element of the cartridge to recognize the unique information of the cartridge; and
a controller configured to control a temperature of the heater of the cartridge,
wherein the main body couples to the cartridge, and the controller of the main body controls an operation of the aerosol generating device based on the unique information of the cartridge recognized by the cartridge recognizer.

8. The aerosol generating device of claim 7, wherein
the specific pattern is formed by one or more protrusions, and represents the unique information of the cartridge differently according to a number of the protrusions, a number of the recesses, positions of the protrusions, and positions of the protrusions, and
the cartridge recognizer of the main body comprises physical switches provided in a number that is equal to a sum of the number of the protrusions and the number of the recesses, and recognizes the unique information of the cartridge based on at least one of the physical switches being clicked by the protrusions of the cartridge.

9. The aerosol generating device of claim 7, wherein
the specific pattern is formed by two or more electrodes, and represents the unique information of the cartridge differently according to a number of the electrodes and positions of the electrodes, and
the cartridge recognizer of the main body comprises recognition terminals provided in a number that is greater than or equal to the number of the electrodes, and recognizes the unique information of the cartridge based on a current which flows through at least one of the recognition terminals contacting the electrodes of the cartridge.

10. The aerosol generating device of claim 9, wherein
the electrodes of the information storage element of the cartridge comprise one or more positive electrodes and one or more negative electrodes,
the cartridge recognizer of the main body comprises a negative electrode pad comprising two or more negative electrode terminals and a positive electrode pad comprising two or more positive electrode terminals, and
each of the positive electrodes and the negative electrodes corresponds one-on-one to one of the negative electrode terminals of the negative electrode pad and the positive electrode terminals of the positive electrode pad.

11. The aerosol generating device of claim 7, wherein the unique pattern about the information storage element of the cartridge is pre-stored in the main body, and the controller authenticates the cartridge based on whether the recognized unique pattern matches the pre-stored unique pattern.

12. The aerosol generating device of claim 11, wherein the controller generates an alarm, or block an operation of the aerosol generating device, when the authentication fails.

13. The aerosol generating device of claim 7, wherein the controller of the main body adjusts a heating temperature of the heater of the cartridge, based on the unique information of the cartridge recognized by the cartridge recognizer.
